(19) United States
(12) Patent Application Publication
(10) Pub. No.: US 2016/0217256 A1
(43) Pub. Date: Jul. 28, 2016

(54) METHOD AND SYSTEM FOR GENERATING AN ELECTRONIC HEALTH RECORD INCLUDING PATIENT PROGRESS NOTES

(71) Applicant: Back Kyun Kim, Flushing, NY (US)

(72) Inventor: Back Kyun Kim, Flushing, NY (US)

(21) Appl. No.: 14/605,117

(22) Filed: Jan. 26, 2015

(51) Int. Cl. G06F 19/00

(52) U.S. Cl. CPC G06F 19/322; G06F 19/345

(57) ABSTRACT

A method and system for enhancing the accuracy and efficiency of the electronic health record by quickly creating a progress note entered by a physician with the assistance of a computer readable storage means. The progress note includes a plurality of fields, which contain symptom data and information. The method includes selecting at least one electronic symptom template suited for a specific patient symptom out of the plurality of given electronic symptom templates stored in the storage means. The method then generates a pre-populated progress note wherein symptom data and information is retrieved from the storage means and automatically entered into each field of the progress note. The method and system then provides recommendations, common diagnoses and treatment plans appropriate to the selected symptom.

### BACKGROUND OF THE INVENTION

1. Field of the Invention

This invention relates generally to a method for generating, with the assistance of a computer system, an electronic health record documenting patient progress notes. More specifically, a method and system for enhancing the accuracy and efficiency of the electronic health record by quickly creating a progress note based on a physician-selected symptom and provides recommendations, common diagnoses and treatment plans appropriate to the selected symptom.

2. Description of the Related Art

Millions of people visit doctors each year. Every time a patient visits a doctor, the doctor spends a significant amount of time documenting the patient's history and progress. A progress note is a document drafted by a physician that describes a patient's condition after examination. Typical progress notes are drafted after the physician and patient meet and can be extremely tedious and time consuming to accurately complete.

The Centers for Medicare and Medicaid Services (CMS) govern the medical industry and have provided criteria that must be met for medical documentation, including criteria for progress notes. To comply with federal regulations, a progress note must contain the following sections Chief Complaint, History of Present Illness (HPI), Review of Symptoms (ROS), Past-Family-Social History, Physical Examination, Diagnoses, and Treatment Plan.

There are several electronic medical record (“EMR”) software systems currently available. All of them contain a progress note creation process that includes the sections described above. However, most EMR software systems require each section be documented separately or, if presented in the same page, require the physician to fill out each section independent of the others as shown in FIG. 1. This requires the physician to navigate to different sections of a standardized report and input repetitive information.

While these software systems may be suitable for the particular purpose employed, or for general use, they are not be as suitable for the purposes of the present invention as disclosed hereafter.

It is, therefore, a primary object of the present invention to provide a method and system for enhancing the accuracy and efficiency of the electronic health record by quickly creating a progress note based on a physician-selected symptom and providing recommendations, common diagnoses and treatment plans appropriate to the selected symptom.

It is, therefore, another object of the present invention to provide an integrated system that significantly reduces the time a doctor must spend documenting a patient's progress notes.

### BRIEF SUMMARY OF THE INVENTION

In accordance with one aspect of the present invention a method for creating a progress note for a patient having a plurality of fields, which contain symptom data and information is provided. The method comprises identifying at least one specific patient symptom and selecting at least one electronic symptom template suited for the specific patient symptom out of a plurality of given electronic symptom templates stored in storage means. Next, the method includes merging symptom data of at least two electronic symptom templates corresponding to each field of the progress note and generating a pre-populated progress note for the patient based on the merged symptom data from the selected electronic symptom template.

The method may further include automatically entering the history of present illness corresponding to the at least one electronic symptom template entered.

The method may further include automatically generating suggested medication and dosage codes corresponding to the at least one electronic symptom template entered.

The method may further include automatically generating a diagnosis and billing code data corresponding to the at least one electronic symptom template entered.

The method may further include automatically generating a treatment plan corresponding to the automatically generated diagnosis.

The electronic symptom template may contain color-coded symptom data throughout the progress note.

In accordance with an additional embodiment of the present invention, a method of enhancing the accuracy and efficiency of electronic progress notes entered by a physician with the assistance of a computer readable storage means is provided, wherein the electronic progress note includes a plurality of fields which contain symptom data and information. The method includes selecting at least one electronic symptom template suited for a specific patient symptom out of a plurality of given electronic symptom templates stored in the storage means, and generating a pre-populated progress note wherein symptom data and information stored in the storage means is automatically entered into each field of the progress note.

The method may further include selecting multiple electronic symptom templates and merging symptom data from the multiple templates together within each associated field to create the progress note.

The electronic symptom template may contain color-coded symptom data throughout the progress note.

The fields of the progress note may include chief complaint, history of present illness, review of symptoms, past-family-social history, physical examination, diagnoses, and treatment plan.

The method may include allowing the physician to review, edit and approve symptom data and information automatically entered into each field of the progress note.

The method may further include automatically generating suggested medication and dosage codes corresponding to the at least one electronic symptom template entered.

The method may further include automatically generating a diagnosis and billing code data corresponding to the at least one electronic symptom template entered.

The method may further include automatically generating a treatment plan corresponding to the automatically generated diagnosis.

In accordance with an additional embodiment of the present invention, a method of enhancing the accuracy and efficiency of electronic progress notes entered by a physician with the assistance of a computer readable storage means is provided, wherein the electronic progress note includes a plurality of fields which contain symptom data and information. The method comprises selecting at least one electronic symptom template suited for a specific patient symptom out of a plurality of given electronic symptom templates stored in the storage means, and generating a pre-populated progress note by merging symptom data from multiple selected electronic symptom templates within each associated field of the progress note. The method then includes reviewing, editing and approving symptom data by a physician entered into each field of the progress note. Then, automatically generating suggested medication and dosage codes corresponding to the at least one electronic symptom template entered. Then, automatically generating a diagnosis and billing code data corresponding to the at least one electronic symptom template entered. Finally, automatically generating a treatment plan corresponding to the automatically generated diagnosis.

The method may further include automatically generating a diagnosis and billing code data corresponding to the at least one electronic symptom template entered.

The method may further include automatically generating a treatment plan corresponding to the automatically generated diagnosis.

In accordance with an additional embodiment of the present invention, a system for creating a progress note with the assistance of a computer readable storage means is provided, wherein the progress note includes a plurality of fields, which contain symptom data and information. The system includes means for selecting at least one electronic symptom template suited for a specific patient symptom out of a plurality of given electronic symptom templates stored in the storage means, and means for generating a pre-populated progress note wherein symptom data and information stored in the storage means is automatically entered into each associated field of the progress note.

The system may further include means for providing recommendations, common diagnoses and treatment plans to the specific patient appropriate to the selected symptom.

The system may further include means for merging symptom data from multiple selected electronic symptom templates together within each associated field to create the progress note.

### BRIEF DESCRIPTION OF THE SEVERAL VIEWS OF THE DRAWINGS

To these and to such other objects that may hereinafter appear, the present invention relates to a method and system for enhancing the accuracy and efficiency of the electronic health record by quickly creating a progress note based on a physician-selected symptom as described in detail in the following specification and recited in the annexed claims, taken together with the accompanying drawings, in which like numerals refer to like parts in which:

FIG. 1 is a schematic of a traditional progress note showing each component requiring independent input from one another;

FIG. 2 is a block diagram of the system and method for efficiently documenting a progress note in accordance with the present invention;

FIG. 3 is a block diagram of the system and method for efficiently documenting a progress notes in accordance with the present invention, and providing a pre-populated progress note template based on a compilation of physician-selected symptoms;

FIG. 4A is a screenshot of a progress note template according to the present invention;

FIG. 4B is a screenshot of a progress note template according to the present invention to demonstrate selection of the chief complaint component;

FIG. 4C is a screenshot of a progress note template according to the present invention to demonstrate the physician-selected symptoms;

FIG. 4D is a screenshot of a progress note template according to the present invention to demonstrate creating a new progress note template;

FIG. 4E is a screenshot of a progress note template according to the present invention to demonstrate the physician-selected symptom templates;

FIG. 4F is a screenshot of a progress note template according to the present invention to demonstrate the customizable physician-selected symptom templates;

FIG. 4G is a screenshot of a progress note template according to the present invention;

FIG. 5 is a screenshot of a progress note template according to the present invention to demonstrate the chief complaint section;

FIG. 6A is a screenshot of a progress note template according to the present invention to demonstrate the HPI section;

FIG. 6B is a screenshot of a progress note template according to the present invention to demonstrate the HPI section;

FIG. 6C is a screenshot of a progress note template according to the present invention to demonstrate the HPI section;

FIG. 6D is a screenshot of a progress note template according to the present invention to demonstrate the HPI section;

FIG. 7 is a screenshot of a progress note template according to the present invention to demonstrate the ROS section;

FIG. 8 is a screenshot of a progress note template according to the present invention to demonstrate the family history section;

FIG. 9A is a screenshot of a progress note template according to the present invention to demonstrate the PE section;

FIG. 9B is a screenshot of a progress note template according to the present invention to demonstrate the PE section;

FIG. 10 is a screenshot of a progress note template according to the present invention to demonstrate the suggested diagnosis section;

FIG. 11 is a screenshot of a progress note template according to the present invention to demonstrate the suggested medication section;

FIG. 12A is a screenshot of a progress note template according to the present invention to demonstrate the CPOE section;

FIG. 12B is a screenshot of a progress note template according to the present invention to demonstrate the CPOE section;

FIG. 12C is a screenshot of a progress note template according to the present invention to demonstrate the CPOE section;

FIG. 12D is a screenshot of a progress note template according to the present invention to demonstrate the CPOE section;

FIG. 12E is a screenshot of a progress note template according to the present invention to demonstrate the CPOE section;

FIG. 12F is a screenshot of a progress note template according to the present invention to demonstrate the CPOE section;

FIG. 13 is a flow chart showing the method for efficiently documenting a progress notes in accordance with the present invention, and providing a pre-populated progress note template based on a compilation of physician-selected symptoms;

FIG. 14 is a flow chart showing a system for efficiently documenting a progress note in accordance with the present invention;

FIG. 15 is a flow chart showing a method for efficiently documenting a progress note by a physician in accordance with the present invention; and

FIG. 16 is a schematic view of three physician-selected symptom templates compiled in accordance with the method of the present invention.

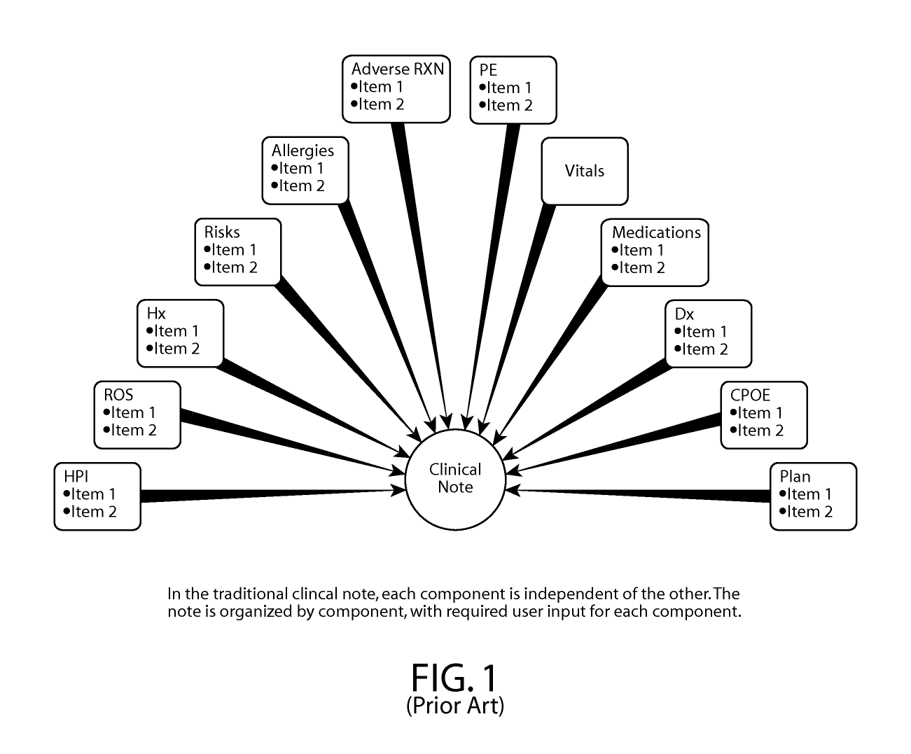

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### DETAILED DESCRIPTION OF THE INVENTION

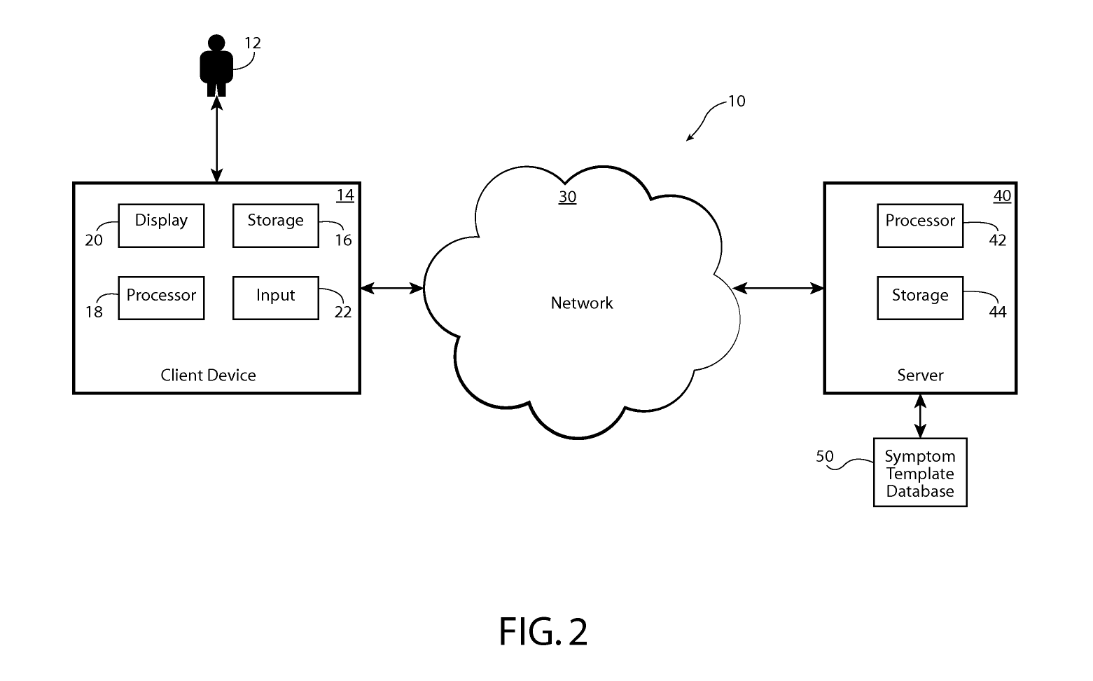

FIG. 2 is a flow chart illustrating the preferred system 10 of the present invention for enhancing the accuracy and efficiency of an electronic medical record (EMR) by creating a progress note 11 based on a physician-selected symptom and providing recommendations, common diagnoses and treatment plans appropriate to the selected symptom.

The system 10 includes at least one client device 14 in communication with one or more servers 40 over a network 30. In some embodiments, the server may be a personal computer. In other embodiments, the server may be a plurality of servers in communication. The server is connected to a communication network 30. For example, the server may be a part of a hospital data network. The network 30 may include a local area network, the Internet, intranet, wide area network or other like network. The users 12 are preferably physicians, nurses, medical personnel, or any other person. The physicians preferably utilize the client devices 14 to communicate with the server 40. The client devices 14 and the server 40 may be configured to communicate via wired or wireless links or a combination of the two.

The client devices 14 may represent a desktop computer, laptop computer, mobile phone, person digital assistant, tablet device or other type of computing device. Each of the client devices 14 may include at least one computer storage means 16 (for example, including but not limited to RAM, ROM, PROM, SRAM) and at least one processing means 18 (preferably a central processing unit) that are capable of executing computer program instructions. The client device 14 in some embodiments is a device that primarily handles input (e.g., user interaction) and output (e.g., displaying), while processing is done on separate server. In other embodiments processing of the clinical data is done on the client device 14. The computer storage means 16 is preferably a physical, non-transitory medium. Any of the client devices 12 may preferably include a display 20 that is capable of rendering an interface and one or more input devices 22 (for example, but not limited to, keyboard, microphone, camera, video camera, scanner, joystick, remote control).

The server 40 may also include at least one processor 42 and at least one computer storage means 44, which is preferably a physical, non-transitory medium. The server 40 preferably includes any computing device capable of communicating with the client device 12.

The server 40 may cooperate with a client device 12 to generate electronic medical records. The present invention is focused on the portion of the electronic medical record called the progress note.

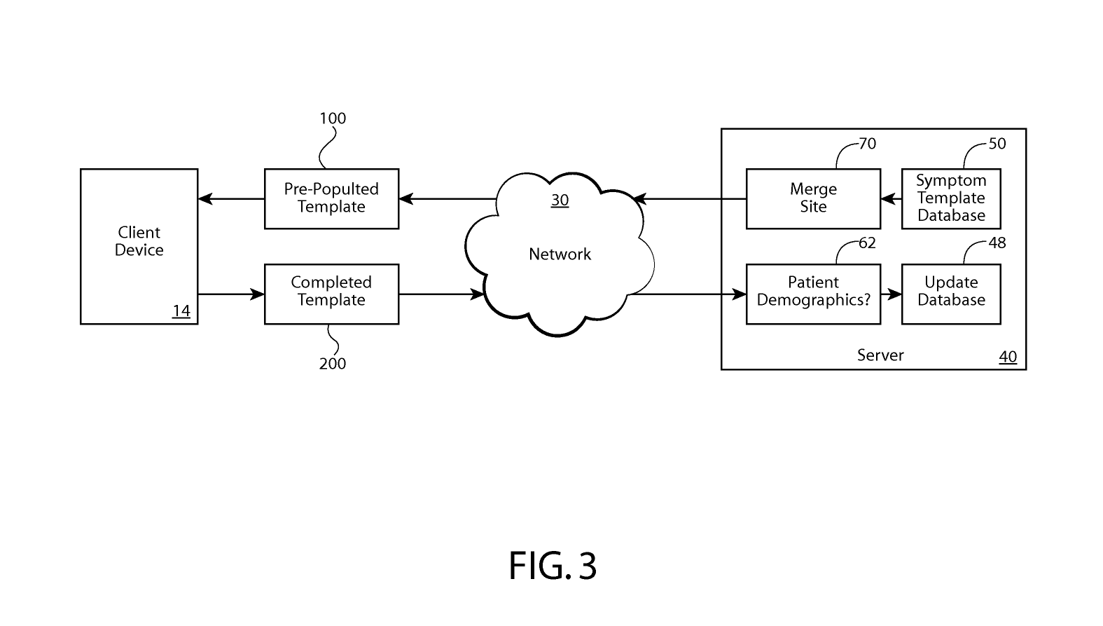

In reference to FIG. 3, the system 10 includes at least one symptom template database 50 in communication with the server 20. The symptom template database 50 includes a plurality of symptom templates 60. At least one, but preferably more than one, symptom template 60 is selected from the symptom template database 50 in order to create a pre-populated progress note 100. In reference to FIG. 3, in the preferred embodiment of the present invention, the software 70 executing on the server 40, automatically merges the data of each symptom template selected, along with the patient demographic data 62, and pre-populates the fields or components of the progress note 100 prior to transmitting the note 100 to a client device 14. The pre-populated template 100 is transmitted to the client device 50 via a communication network 30. The pre-populated template 100 is displayed on the display 20 for the physician 12.

In further reference to FIG. 3, the symptom template database is in communication with the server 20. The symptom template database 50 includes at least one template. For example, the symptom template database 50 may include several standardized symptom templates for particular health care facility relating to a specific type of ailment the patient is suffering. In other embodiments the symptom template database 50 may include a subset of templates having clinical data fields related to a specific department of a health care facility.

The pre-populated progress note template 100 is displayed on an interface of the physician 12. For example, the progress note 100 is displayed on a touch screen tablet. The physician can enter additional clinical data components to the pre-populated progress note 100 using the interface, for example, a keyboard, touch screen, or other input device on the client device 14. In some embodiments the client device 14 includes a keyboard or voice control for entering data components into the progress note 100. In other embodiments, the progress note template 100 includes one or more fields with drop down menus, or selection boxes, thereby providing a series of components for the physician to select.

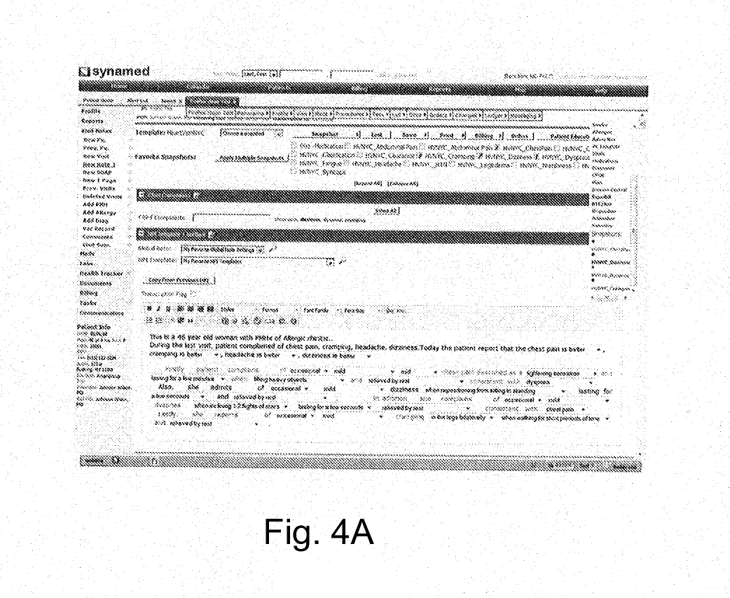

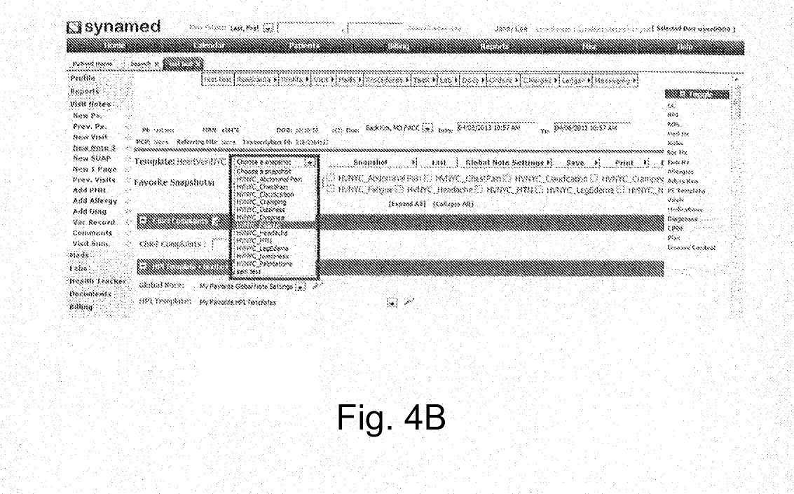

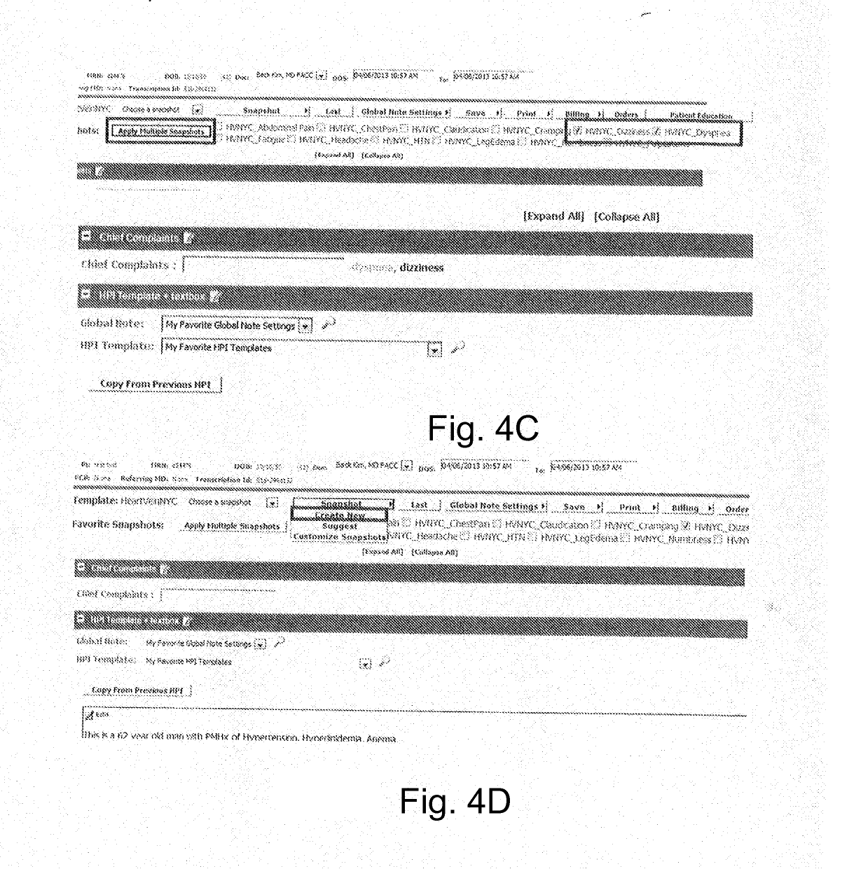

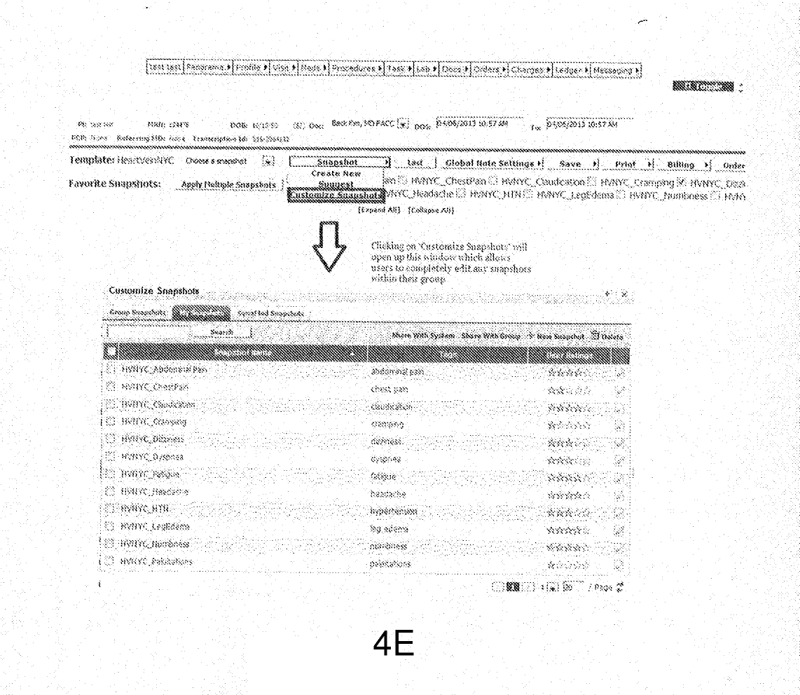

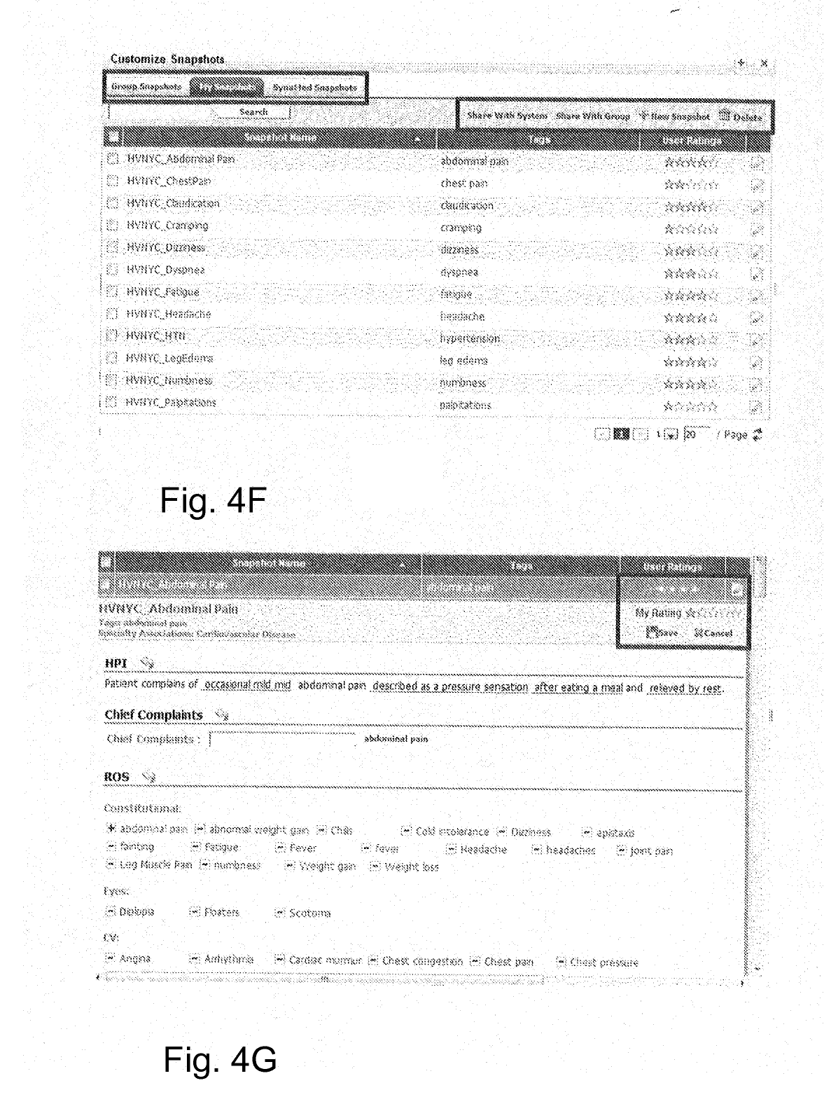

In reference to FIGS. 4A-4F, the pre-populated progress note template 100 in accordance with the preferred embodiment of the present invention is shown. The template 50 is separated into different component sections or fields 110, 120, 130, 140, 150, 160, 170 corresponding to one or more clinical data components, for example Chief Complaint, History of Present Illness (HPI), Review of Symptoms (ROS), Past-Family-Social History, Physical Examination, Diagnoses, and Treatment Plan. The template may be customized to include other components separate from the above, embedded into the template directly in a customizable order. These additional components may include critical alerts, superbill and other useful components.

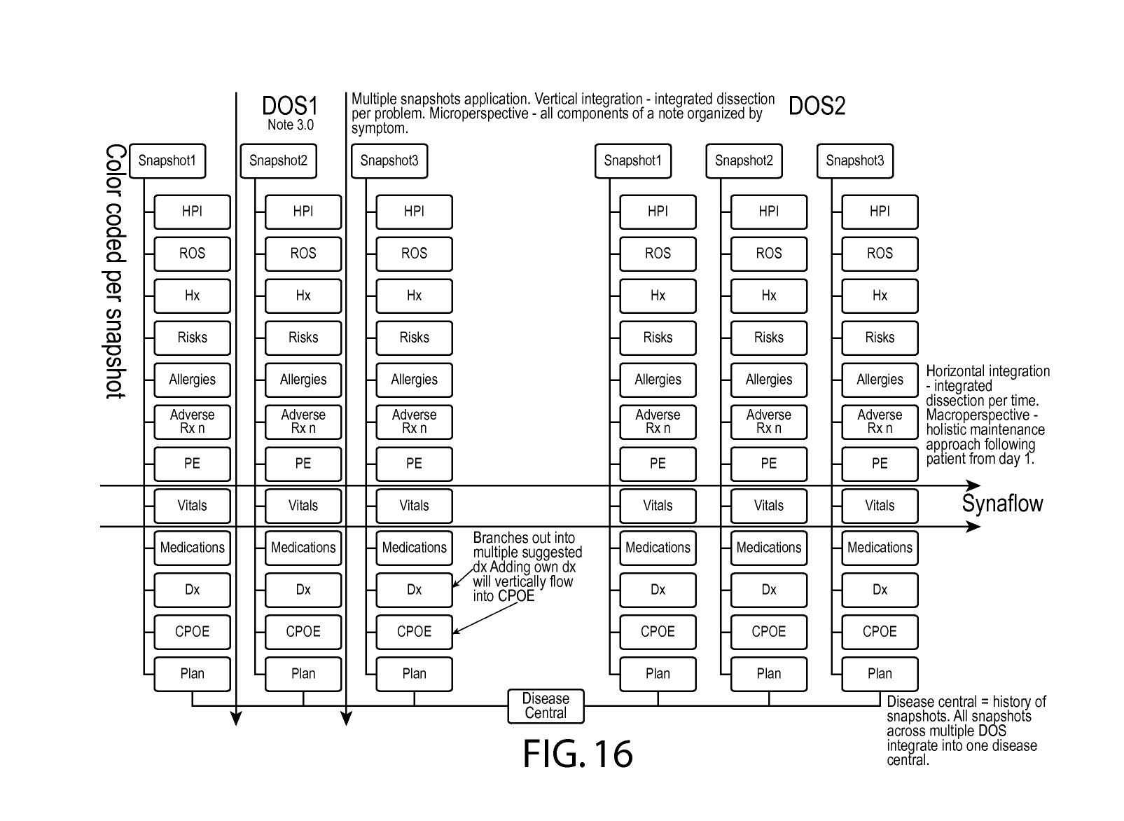

In reference to FIG. 5, the template 100 includes the chief complaint section 110, which includes fields corresponding to the symptom(s) the patient is complaining of. In reference to FIG. 16, multiple symptoms can be selected from the symptom template database 50. The symptoms templates 60 selected are ranked and recorded in the order selected. The data associated with each symptom template 60 is color coded to correspond to that symptom template through the pre-populated progress note. When the symptom templates are merged together by the software 70 to create pre-populated progress note template 100 all symptom templates 60 corresponding to the same chief complaint are viewable within the progress note template 100 by color.

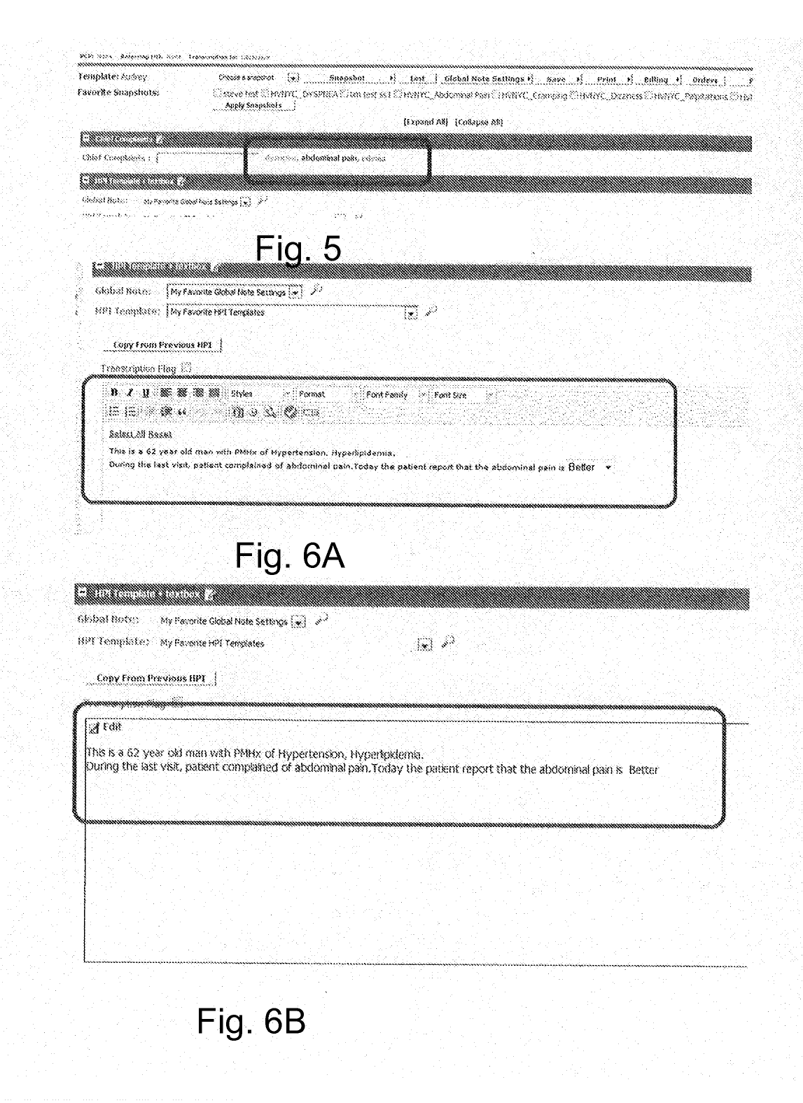

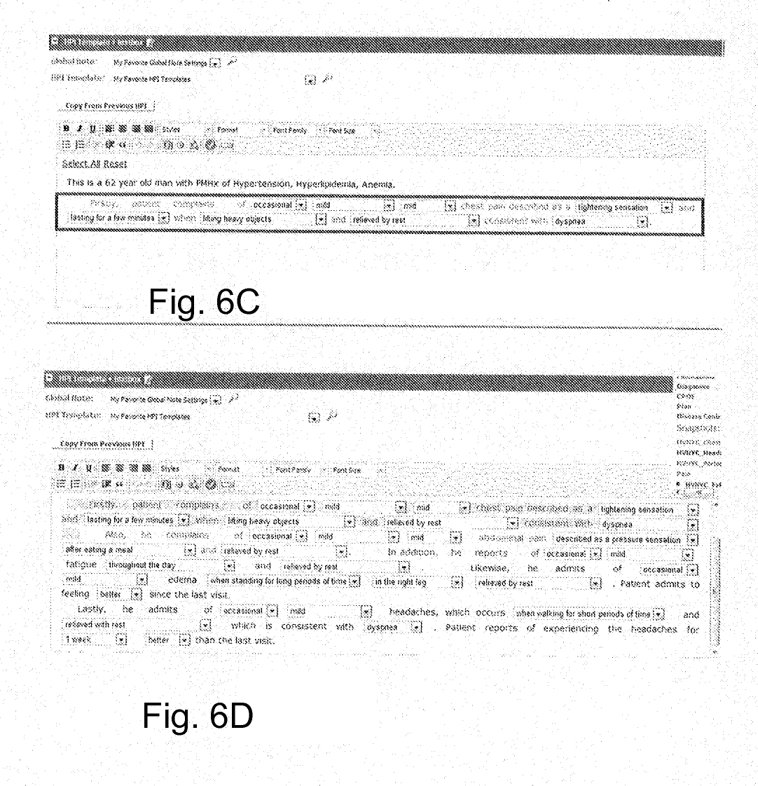

In reference to FIGS. 6A-6D, the template 100 includes the HPI section 130, which includes a descriptive paragraph field 132. The HPI section 130 includes a first pre-generated sentence 132A which includes the patient age 134, patient sex 136, and medical history 138 automatically inputted therein, preferably by drop down menu with pre-populated choices where applicable. More specifically the sentence 132A reads, “This is a [insert age] year old [insert sex] with a PMHx of [insert history].” A second pre-generated sentence 132B is inserted, which specifically reads “During the last visit, patient complained of [previous chief complaint inserted]. Today the patient reports that the [previous chief complaint] is [better, same, worse].” The data is preferably entered into the textbox directly by selections contained within dropdown boxes that are easily chosen by the physician.

After the pre-populated sentences are completed, the physician can approve the changes and the sentence will change back to the default black color. If the physician does not want to use one of the suggested sentences, they may leave it alone and the sentence will disappear after the physician hits the approval button #. There is a select all button # which can be used to quickly approve all the sentences that were pre-populated in the progress note 100.

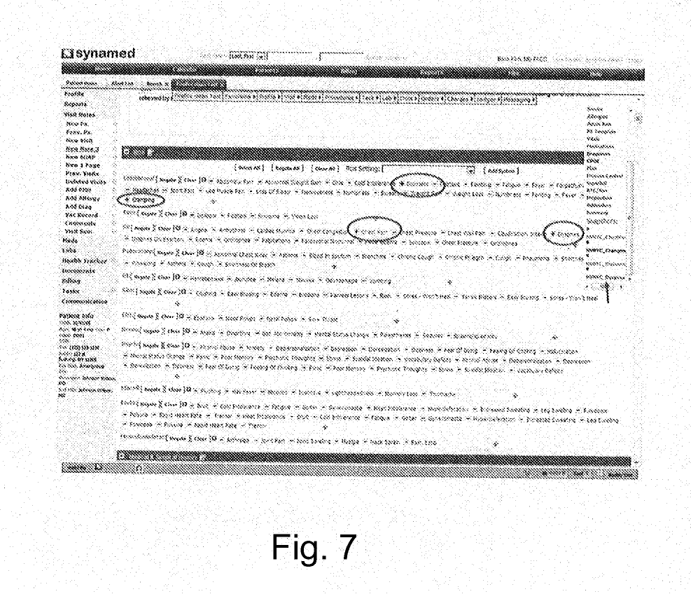

In reference to FIG. 7, the template 100 includes the ROS section 140, which includes a list of symptoms associated with the chief complaint. Positive values for each symptom are color-coded, while negative values remain as default. The physician is able to approve the suggested symptoms and add or delete symptoms from the list.

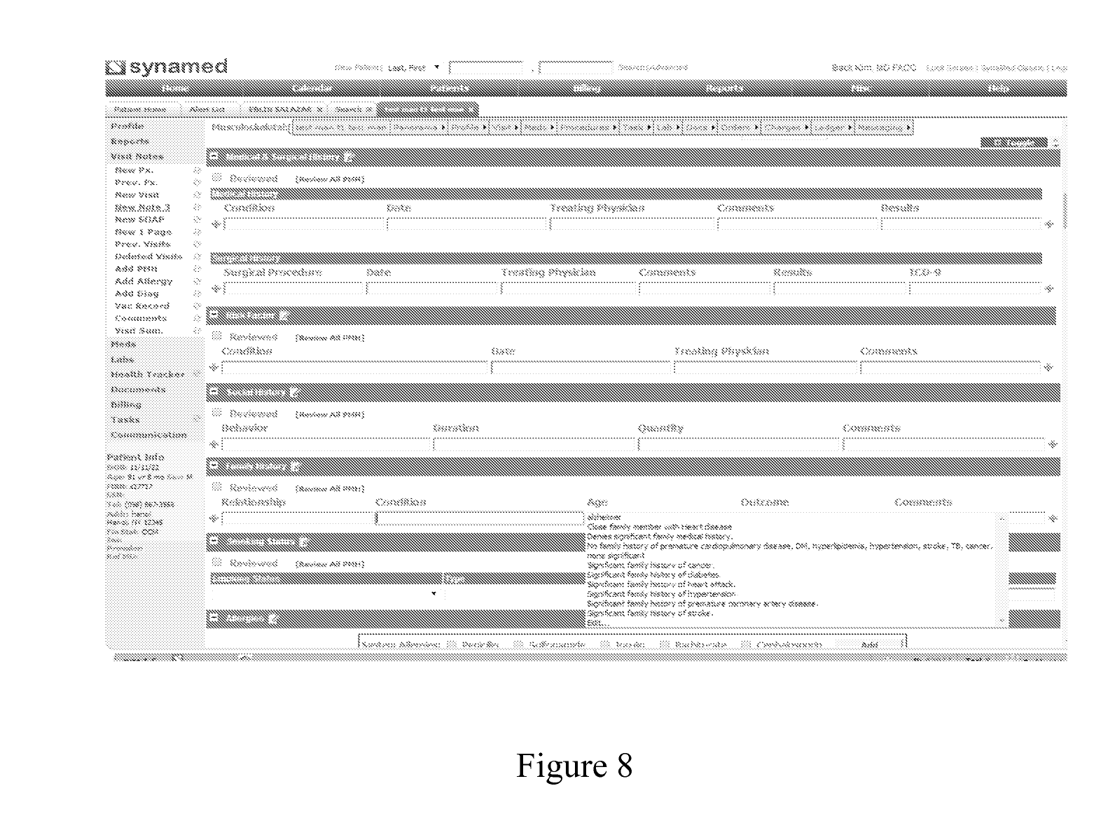

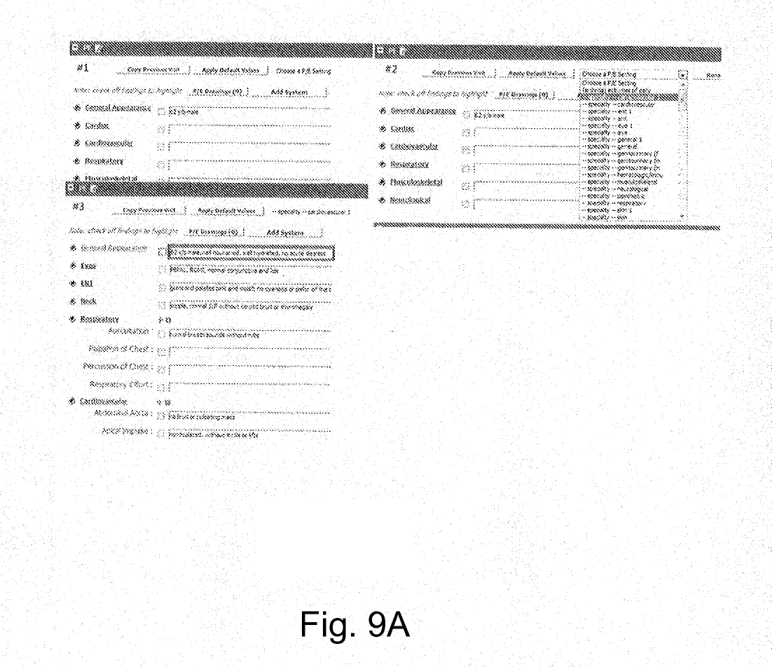

In reference to FIG. 8, the template 100 includes the past-family-social-history section 150, which contains family history data fields.

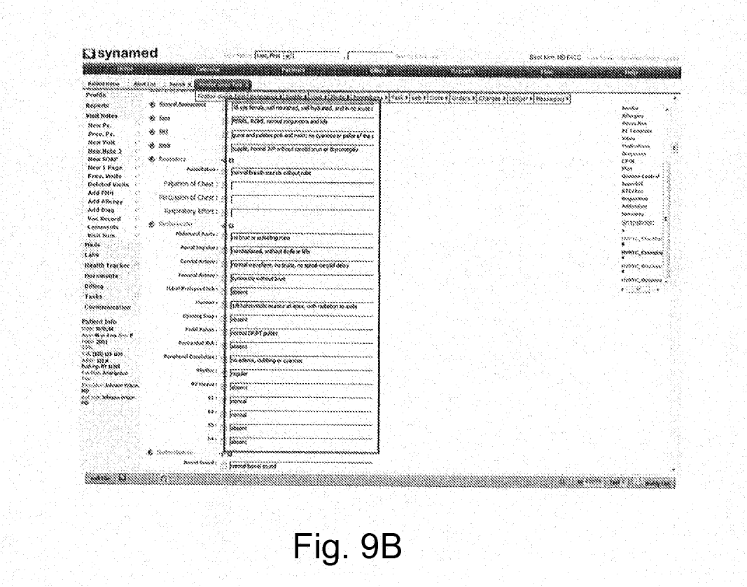

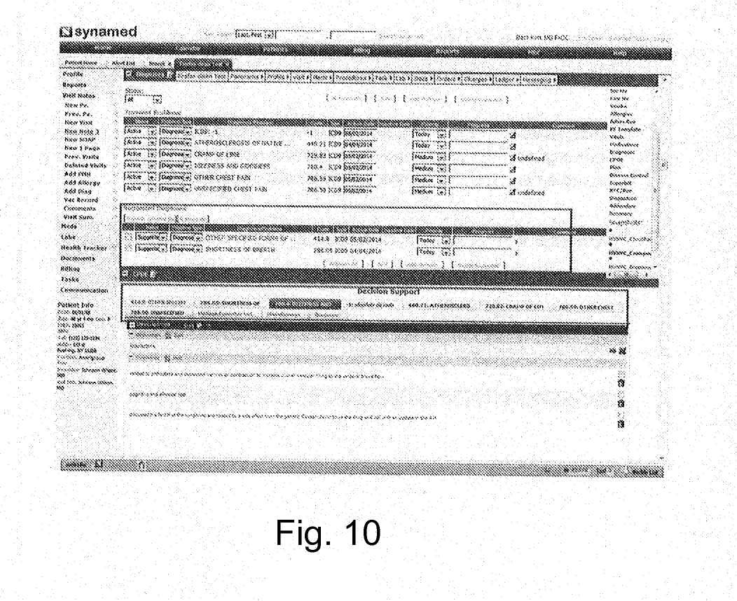

In reference to FIGS. 9A and 9B, the template 100 includes the physical examination section 160. This section 160 automatically includes the age and sex of the patient, which is pre-populated from the patient profile demographics and merged by the software into the template.

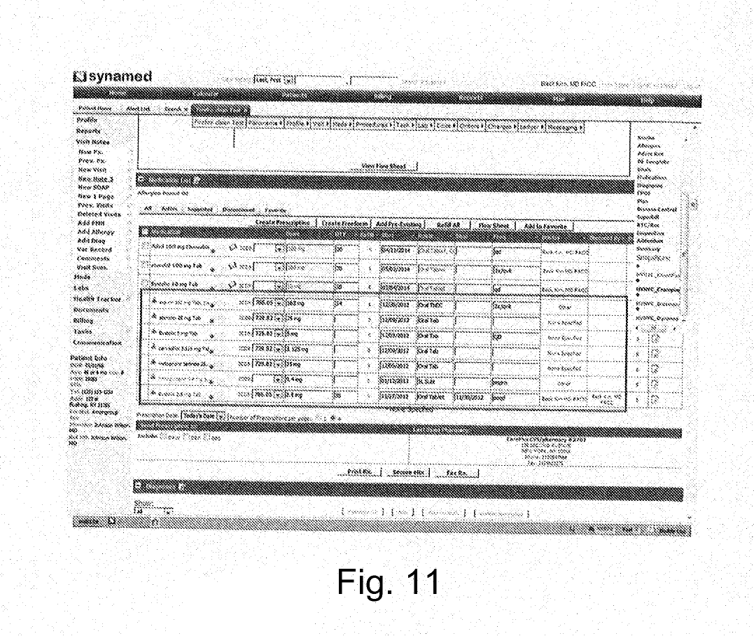

In reference to FIG. 10, a plurality of suggested diagnosis codes are automatically provided which relate to the symptoms selected. A plurality of ICD-9 or ICD-10 codes are then automatically suggested by the system and may be selected or approved by the physician. For instance, if varicose veins is the symptom template chosen, then five options would be suggested for diagnosis including: 454.0 varicose veins of lower extremities with ulcer; 454.1 varicose veins of lower extremities with inflammation; 454.2 varicose veins lower extremities with ulcer and inflammation; 454.8 varicose veins of lower extremities with other complications; 454.9 varicose veins of lower extremities with asymptomatic varicose veins. If multiple symptom templates are chosen the suggested list will include multiple ICD-9 or ICD-10 codes related to either symptom, which the physician may activate to accept.

The diagnosis suggested has four different statuses including active, inactive, resolved and suggested. Active include those currently in use on date of service and are derived from either new diagnosis or activating a suggested diagnosis. The inactive diagnosis are old diagnosis that were originally active in a previous note. The resolved diagnosis is to document previous diagnoses that were resolved. The suggested are those automatically populated by the system once the symptom template is chosen and include their own color codes in accordance with the symptom. These also create tabs in the computerized physician order entry (CPOE) section of the system. Physicians can check boxes next to the suggested diagnosis or select the button “activate all” to accepted all suggested diagnosis.

In reference to FIG. 11 a plurality of suggested medications are automatically provided which relate to the diagnosis selected. The medications suggested have four different statuses including active, suggested, discontinued and favorite. Active includes those currently being taken by the patient. Suggested includes those automatically provided by the system. Discontinued includes those the patient used to take in the past. Favorite includes those designated for a specific practice.

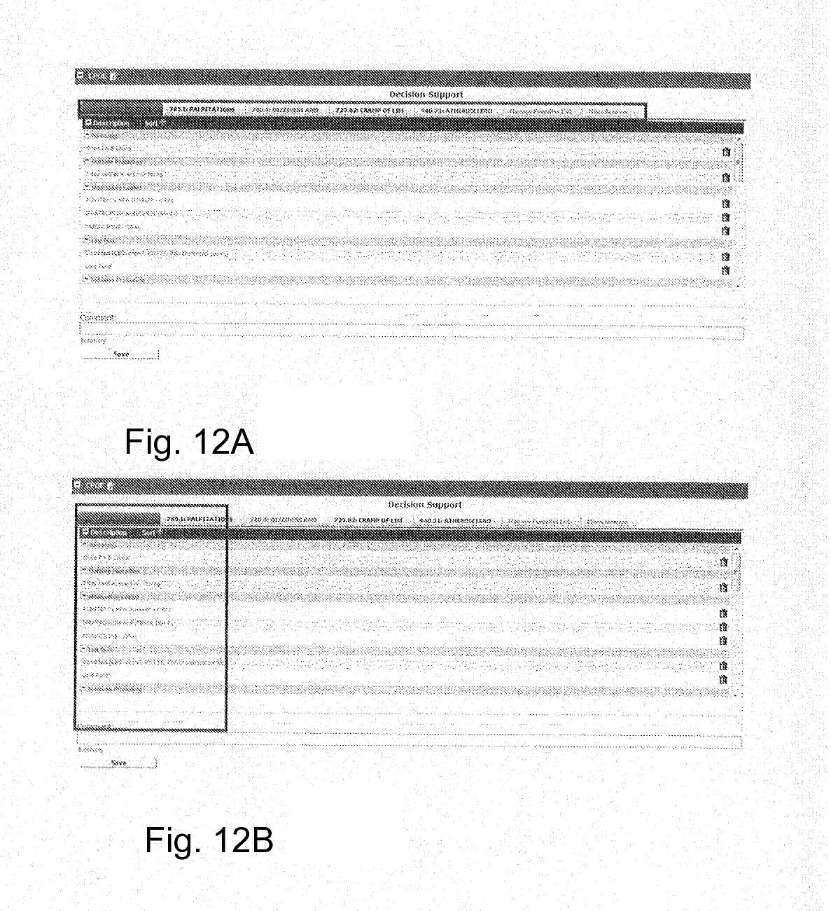

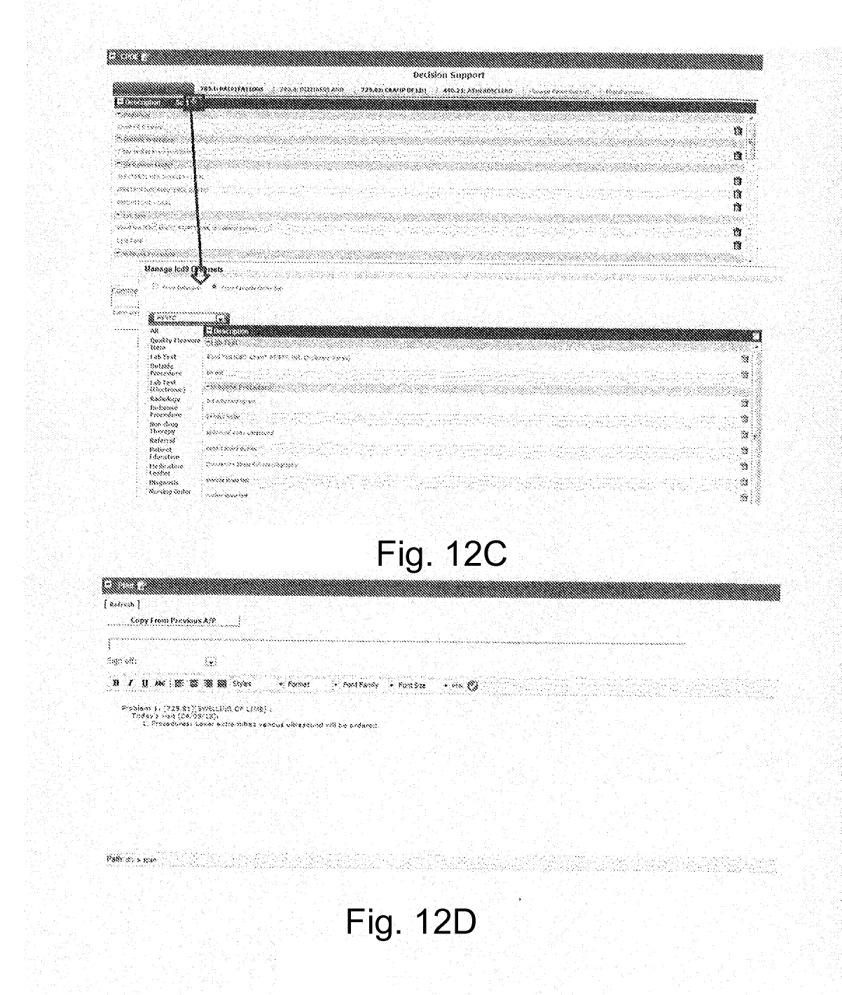

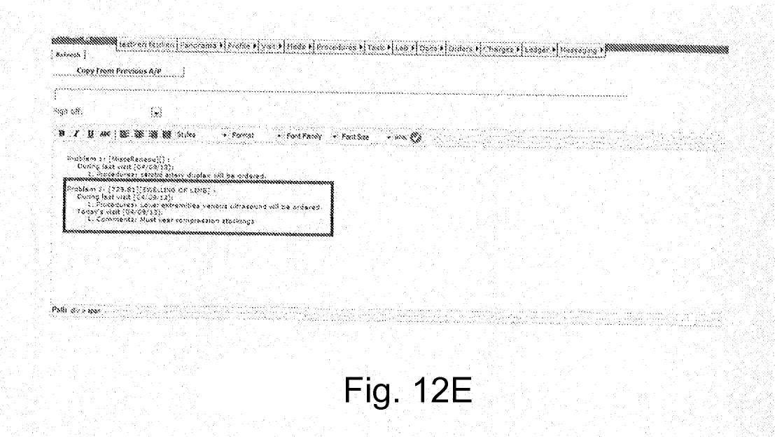

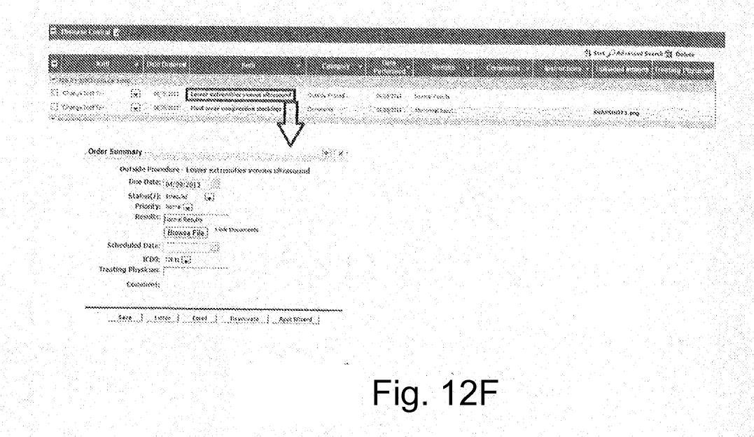

In reference to FIGS. 12A-12E, the template 100 includes the computerized physician order entry (CPOE) section of the system. This section is directly linked to the diagnoses section. When a physician accepts a suggested diagnosis a tab is created in the CPOE section and color-coded to match the symptom template, which lead to the diagnosis. The CPOE allows the physician to order and document all exams, treatments, referrals, medications and lab results for each patient with the appropriate ICD-9 code. Under each ICD-9 code, physicians are able to customize a list of CPOE items. When the desired item is not on the list, physicians may add the item by clicking the “+” feature. A favorites list is available so that a health care provide or practice group can easily access their frequently used CPOE items in a categorized view. After selecting a CPOE item, physicians have the option of automatically selecting or manually entering rationales and instructions. Once completed, the physician can save the entry as a new plan and the ICD-9 code, CPOE item, rationale and instructions are all associated with the progress note. Multiple CPOE items may be entered and are automatically organized by ICD-9 code. After ordering a CPOE item, a sentence is automatically generated in the progress note recounting the previous visit's order summary along with the newest plan.

In reference to FIG. 12F, disease central is shown. Disease central is a summary of all the CPOE items ordered for a patient. In this component field, physicians are able to quickly view all the interventions that were ordered for a patient, along with comments, rationales, instructions and results. Physicians can upload images next to the results for optimized viewing. By clicking on the link provided in the disease central field, a popup window or order summary is shown, with the ability to add, edit or deactivate the item.

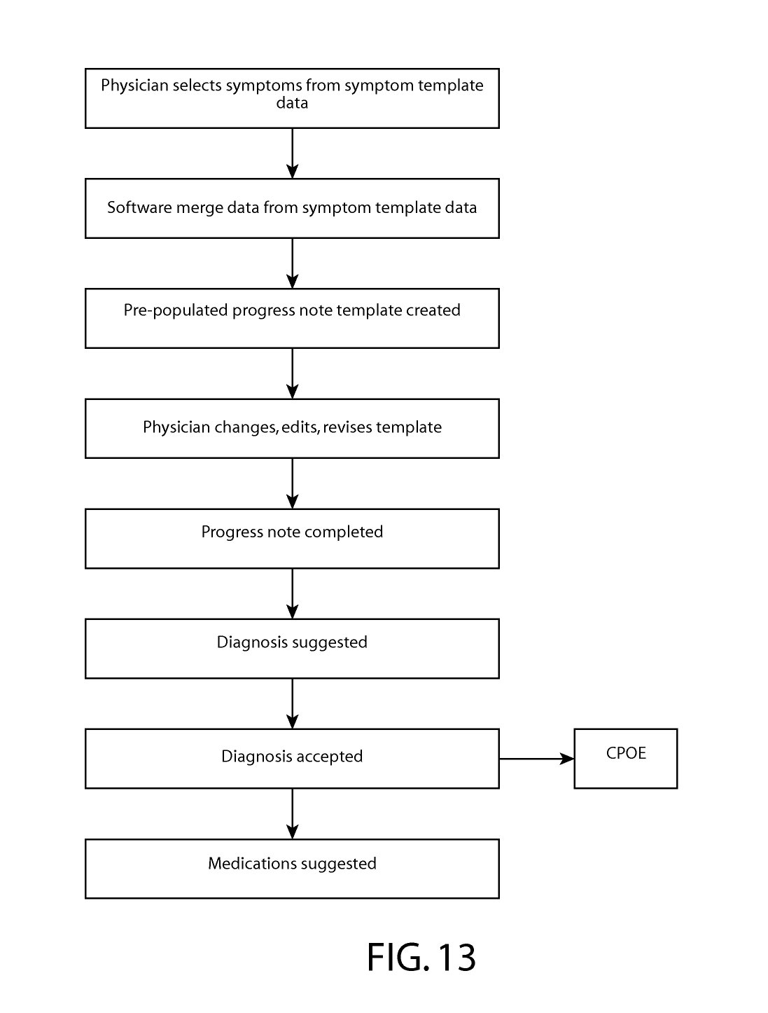

In reference to FIG. 13, a flowchart of the method of the present system 10 is shown. In its broadest context, the physician first selects at least one symptom from the symptom template database 300. Next, the software merges the data from the symptom template database and patient demographic information 310. Then, the system pre-populates the progress note template 320. The physician then makes changes, additions, revisions and deletions to the progress note template 330. Lastly, the physician accepts and completes 340 the comprehensive clinical progress note 200. Once the progress note is completed a suggested diagnosis 350 is provided. An automatically populated list of medications 360 are then suggested deriving from the suggested diagnosis. The suggested diagnosis also triggers the CPOE system.

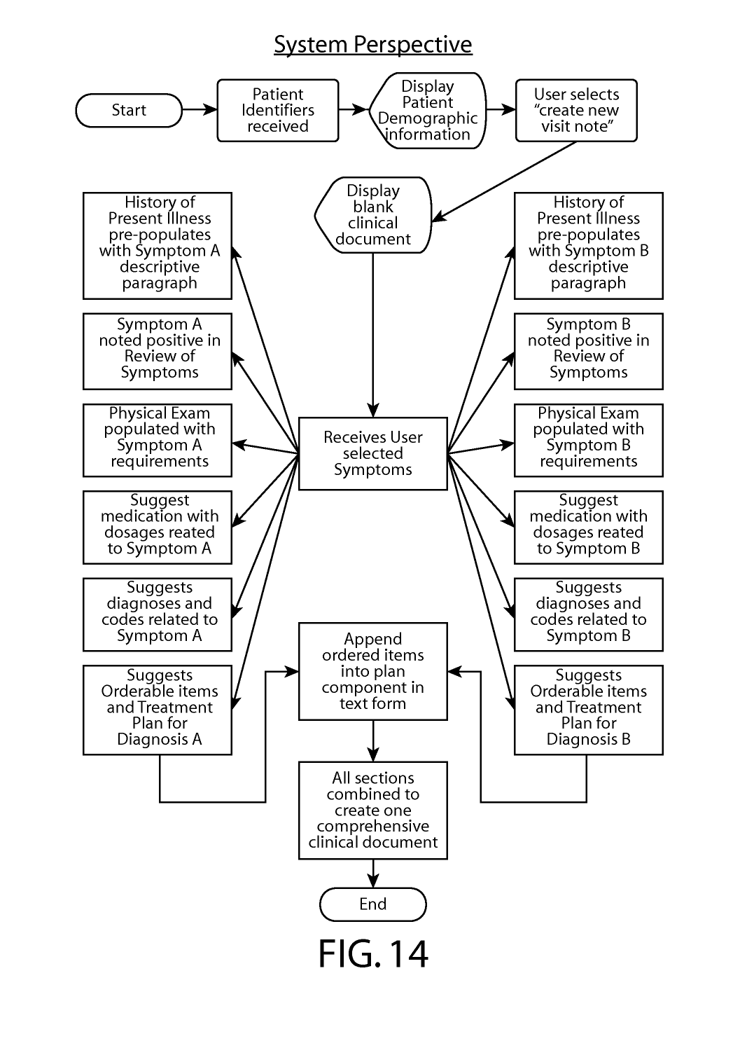

FIG. 14 is a block diagram of the system 10 for quickly creating the progress note 100. The system includes receiving at least one patient identifier. The system displays the patient demographic information and the physician selects the option to create a new visit progress note 100. The display 20 shows a blank clinical progress note 100. The system 10 then receives the physician-selected symptoms. For each symptom selected, the system 10 retrieves the corresponding snapshot or symptom template 60 containing suggested symptom data and information within each component of the pre-populated progress note 100. Specifically, history of the present illness populates a descriptive paragraph within the template retrieved from the symptom template database 46 associated with the present symptom selected. The symptom is noted with the review of symptoms component. The physical exam component populates with the symptom template and retrieves requirements associate with the present symptom selected. The suggested medications and diagnosis are populates with information retrieved from the storage means associated with the present symptom selected. A suggested orderable items and treatment plan component populates with a suggested diagnosis retrieved from the storage means associated with the present symptom selected. The above components are populated for each individual symptom selected and multiple symptoms can be selected. Together the multiple symptom templates are merged to create an appended list of items to be ordered and plan for diagnosis. All templates are merged to create one comprehensive clinical progress note 200.

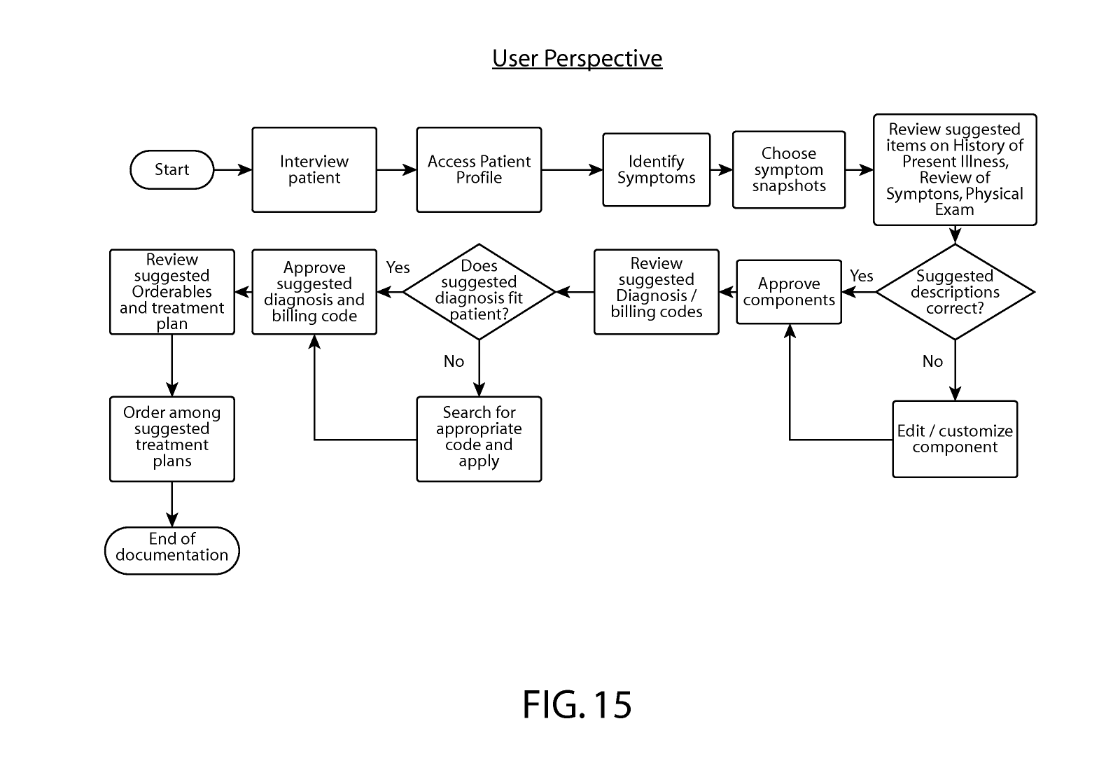

FIG. 15 is a flow chart illustrating a physician interface of the preferred method 100 for creating the progress note 9 in accordance with the present invention. The physician 12 begins the method by interviewing the patient in order to ascertain their symptoms and complaints. The physician 12 accesses the patient profile through the display 20 of the client device 12 and then identifies at least one specific patient symptom 102. The physician then selects the symptom snapshots, or electronic symptom templates 104, suited for the specific patient symptom 102 out of a plurality of given electronic symptom templates 104 stored in the computer storage means 16 or 44. At least two components of the progress note 11 are automatically generated based on the selected symptom template 104. Upon selection of the symptom template 104, symptom data 106 on the basis of symptom information that is stored in the computer storage means 16 or 44 are automatically entered into each component of the progress note 9. The symptom data 106 is first suggested by the system 10 and then the physician is able to confirm the accuracy of the suggested descriptions placed within each component. The symptom data 106 is added to the chief complaints, ROS, physical examination, diagnosis, medications and CPOE components. After the symptom data 106 is added, the physician is able to customize and edit the components and then approve the components. When multiple symptoms 102 are present, multiple symptom templates 104 are selected and the symptom data 106 corresponding to each one is merged into the various components.

The physician is able to review the suggested diagnosis and billing codes and confirm that they are accurate. If they are not accurate, the physician can search for the appropriate diagnosis code and apply it to the symptom template 104. Once the physician approves the diagnosis and billing codes they review the suggested orderables and treatment plan. Next the physician is able to place orders based on the suggested treatment plans. After which, the progress note 9 is completed.

It will now be appreciated that the present invention relates to a method and system for enhancing the accuracy and efficiency of the electronic health record by quickly creating a progress note based on a physician-selected symptom and provides recommendations, common diagnoses and treatment plans appropriate to the selected symptom. The invention is illustrated by example in the drawing figures, and throughout the written description.

It should be understood that numerous variations are possible, while adhering to the inventive concept. Such variations are contemplated as being a part of the present invention.

While only one preferred embodiment of the present invention has been disclosed for purposes of illustration, it is obvious that many modifications and variations could be made thereto. It is intended to cover all of those modifications and variations, which fall within the scope of the present invention as defined by the following claims.

I claim:

1. A method for creating a progress note for a patient having a plurality of fields which contain symptom data and information, said method comprising:
a. identifying at least one specific patient symptom;
b. selecting at least one electronic symptom template suited for said specific patient symptom out of a plurality of given electronic symptom templates stored in storage means;
c. merging symptom data of at least two electronic symptom templates corresponding to each field of said progress note; and
d. generating a pre-populated progress note for said patient based on said merged symptom data from said selected electronic symptom template.

2. The method of claim 1 further comprising:
automatically entering history of present illness corresponding to said at least one electronic symptom template entered.

3. The method of claim 1 further comprising:
automatically generating suggested medication and dosage codes corresponding to said at least one electronic symptom template entered.

4. The method of claim 1 further comprising:
automatically generating a diagnosis and billing code data corresponding to said at least one electronic symptom template entered.

5. The method of claim 4 further comprising:
automatically generating a treatment plan corresponding to said automatically generated diagnosis.

6. The method of claim 1 wherein each said electronic symptom template contains color-coded symptom data throughout said progress note.

7. A method of enhancing the accuracy and efficiency of electronic progress notes entered by a physician with the assistance of a computer readable storage means, wherein said electronic progress note includes a plurality of fields which contain symptom data and information, the method comprising:
selecting at least one electronic symptom template suited for a specific patient symptom out of a plurality of given electronic symptom templates stored in said storage means; and
generating a pre-populated progress note wherein symptom data and information stored in said storage means is automatically entered into each field of said progress note.

8. The method of claim 7 further comprising: selecting multiple electronic symptom templates and merging symptom data from said multiple templates together within each associated field to create said progress note.

9. The method of claim 7 wherein each said electronic symptom template contains color-coded symptom data throughout said progress note.

10. The method of claim 7 wherein said fields of said progress note include chief complaint, history of present illness, review of symptoms, past-family-social history, physical examination, diagnoses, and treatment plan.

11. The method of claim 7 wherein said physician reviews, edits and approves symptom data and information automatically entered into each said field of said progress note.

12. The method of claim 7 further comprising:
automatically generating suggested medication and dosage codes corresponding to said at least one electronic symptom template entered.

13. The method of claim 7 further comprising:
automatically generating a diagnosis and billing code data corresponding to said at least one electronic symptom template entered.

14. The method of claim 13 further comprising:
automatically generating a treatment plan corresponding to said automatically generated diagnosis.

15. A method of enhancing the accuracy and efficiency of electronic progress notes entered by a physician with the assistance of a computer readable storage means, wherein said electronic progress note includes a plurality of fields which contain symptom data and information, the method comprising:
selecting at least one electronic symptom template suited for a specific patient symptom out of a plurality of given electronic symptom templates stored in said storage means;
generating a pre-populated progress note by merging symptom data from multiple selected electronic symptom templates within each associated field of said progress note;
reviewing, editing and approving symptom data by a physician entered into each said field of said progress note;
automatically generating suggested medication and dosage codes corresponding to said at least one electronic symptom template entered;
automatically generating a diagnosis and billing code data corresponding to said at least one electronic symptom template entered; and
automatically generating a treatment plan corresponding to said automatically generated diagnosis.

16. The method of claim 15 further comprising:
automatically generating a diagnosis and billing code data corresponding to said at least one electronic symptom template entered.

17. The method of claim 16 further comprising:
automatically generating a treatment plan corresponding to said automatically generated diagnosis.

18. A system for creating a progress note with the assistance of a computer readable storage means, wherein said progress note includes a plurality of fields which contain symptom data and information, comprising:
means for selecting at least one electronic symptom template suited for a specific patient symptom out of a plurality of given electronic symptom templates stored in said storage means; and
means for generating a pre-populated progress note wherein symptom data and information stored in said storage means is automatically entered into each associated field of said progress note.

19. The system of claim 17 further comprising: means for providing recommendations, common diagnoses and treatment plans to said specific patient appropriate to the selected symptom.

20. The system of claim 17, further comprising: means for merging symptom data from multiple selected electronic symptom templates together within each associated field to create said progress note.
